(19) United States
(12) Patent Application Publication
(10) Pub. No.: US 2016/0052187 A1
(43) Pub. Date: Feb. 25, 2016

(54) DEVICE AND METHOD FOR BLOW-MOLDING A BLOW TUBE

(71) Applicant: Etimex Technical Components GmbH, Rottenacker (DE)

(72) Inventor: Herbert Werner, Oberdischingen (DE)

(21) Appl. No.: 14/793,890

(22) Filed: Jul. 8, 2015

(30) Foreign Application Priority Data
Aug. 20, 2014 (EP) 14 181 503.5

(51) Int. Cl. B29C 49/02; B29C 49/28

(52) U.S. Cl. CPC B29C 49/02; B29C 49/28; B29C 2049/0089

(57) ABSTRACT

A device for blow-molding a blow tube has a mold cavity into which the blow tube is to be at least partially received. The device further has a mold slider injectable into the mold cavity. The mold slider has to move a wall area of the blow tube into the mold cavity up to a wall area opposite of the blow tube in such a manner that an adhesion of both wall areas results.

### BACKGROUND

1. Field of the Invention

The present invention relates to a device for blow-molding a blow tube or a blow-mold part, having a blow mold, into which mold cavity the blow tube has to be at least partially received, and having a mold slider injectable into the mold cavity. Furthermore, the present invention relates to a method for blow-molding a blow tube having the following steps: inserting or in-bringing a blow tube into a mold cavity of a blow mold and injecting at least one mold slider into the mold cavity.

2. Description of the Related Art

When blow molding, also referred to as extrusion blow-molding process, a parison in the shape of a heated, flexible blow tube made up of thermoplastic plastic is inserted by an extrusion device into the mold cavity of a blow mold. For this purpose, the blow tube may be fully immersed into the mold cavity or the blow tube is bigger than the mold cavity, as a result of which the blow tube extends over the mold cavity. Then, using a closing element, the parison is clamped in the front and back or at the top and on the bottom. Then, the parison is inflated to a finished form and, subsequently, the finished form is cooled. The blow tube is thus inflated by a blowing device, as a result of which the wall areas of the blow tube attach to the insides of the blow mold, the plastic material of the blow tube cools, and in this manner a hollow plastic body having a hollow final shape results. Furthermore, suction blow-molding is known as a blow-molding process, in which a blow tube is conveyed as a parison from a die head of an extrusion device into a closed tool mold or blow mold and a “suctioning” through the blow mold occurs via an air stream. The air stream thus transports the parison and prevents a premature contact of the parison with the tool mold.

Such blowing methods allow for relatively simple and inexpensive blow-molding tools. Blowing methods may thus inexpensively manufacture hollow bodies, in particular, in large serial productions.

Furthermore, such blowing methods are also used to form interior support structures for fiber-reinforced mold parts. During the manufacturing and curing of the fiber-reinforced mold parts, these support structures are utilized as a non-recyclable one-way mold. The support structures are coated with fibers and proofed under pressure using resin. For this purpose, the blow-molding parts have to have a high rigidity, yet they have to be as inexpensive as possible. Furthermore, the blow-molding parts ought to have a closed surface and their material ought to be recycable.

The object of the present invention is to create a device and a method for blow molding, by which stiff hollow body structures may to be created in a cost-effective manner.

### SUMMARY

The present invention relates to a device for blow-molding a blow tube. The device has a blow mold with a mold cavity into which the blow tube is to be at least partially received. The device also has a mold slider injectable into the mold cavity. The mold slider moves a wall area of the blow tube into the mold cavity up to a wall area opposite of the blow tube in such a manner that an adhesion of both wall areas results. The adhesion may also be referred to as welding.

The device according to the present invention and, in particular, its injectable slider, enables to move the wall area into the mold cavity and, furthermore, to bond this wall area with a wall area located on the opposite side. When bonding both wall areas, they are materially bonded or bonded to each other in a material-sealing manner, so that a contact area, also transmitting forces, forms. In a cost-effective manner, a stiffening results inside the hollow body formed for this reason, which is particularly advantageous for working as a one-way mold when manufacturing fiber-reinforced mold parts.

To date, larger, fiber-reinforced mold parts had thin, blow-molded support structures or support structures manufactured by a blowing technique that were too weak. The ribs producible according to the present invention are, however, able to increase the rigidity of the finished form in such a manner that a new scope of application is indicated. Despite thin walls, a high mold stability is provided and this is when at least one surface on the opposite wall area is closed.

Furthermore, the procedure according to the present invention enables to forgo conventional ribs, which were designed in the shape of surface ripples. Injection parts for the mold cavity otherwise necessary, which would have to be produced as separate components, may also be omitted. The achievement according to the present invention also has fewer geometric limitations and the complete support structure may be manufactured in only one work step for the associated fiber-reinforced mold part.

The mold slider may be fully moved out of the mold cavity after bonding both wall areas. The mold slider according to the present invention is, by ejecting it, again removed from the mold cavity and, in this way, a closed surface forms again at the wall of the mold cavity. At the same time, based on the achieved adhesion according to the present invention, the wall area injected into the mold cavity by the mold slider remains as a rib or cross-web in the interior of the mold cavity. Thus, a hollow component having a closed surface at the outside and a rib on the inside results from this procedure. Preferably, the mold slider or mold sliders are thus again ejected from the mold cavity or the component area of the form, as a result of which the wall areas of the blow-mold part moved to the inside are, based on the overpressure taking effect in the interior, pressed against each other and bond in the process. In this way, the gap formed by the mold slider is closed and a smooth, closed surface forms for the blow-mold part.

It is further advantageous according to the present invention to provide a second mold slider, by which the opposite wall area of the blow tube is to be moved into the mold cavity. The second mold slider thus forms a second rib, which is advantageously situated opposite the first mold slider. Based on the second rib, the mold slider of the first rib and of the second rib has to be moved comparably less far or deep into the mold cavity. For this reason, more uniform and thicker walls result at the formed ribs.

Furthermore, the device according to the present invention may provide a blowing device, by which the blow tube may be at least partially inflated before welding the two wall areas. The partial inflation thus occurs advantageously before or during the injection of the first or second mold slider. The partial inflation enables that the parison is pre-aligned and pre-positioned.

Alternatively or in addition, a blowing device is advantageously provided, by which the blow tube is fully inflatable after bonding the two wall areas. The partial inflation thus occurs during or after ejecting the first or second mold slider. It is particularly preferable that the complete inflation occurs only then, when both the first and the second mold slider are fully ejected from the mold cavity.

The invention also provides a method for blow-molding a blow tube having the following steps: inserting a blow tube into the area of the mold cavity of a blow tube and injecting a mold slider into the mold cavity and, for this reason, moving a wall area of the blow tube into the mold cavity until the wall area adheres to an opposite wall area of the blow tube.

The mold slider may again be ejected from the mold cavity after bonding the two wall areas.

Furthermore, a second mold slider is advantageously injected into the mold cavity and, for this reason, the opposite wall area of the blow tube is moved into the mold cavity until the two wall areas are bonded.

The blow tube may be inflated partially before bonding the two wall areas. As described at the onset, the pre-inflation occurs preferably before or during the injection of the first or second mold slider. Alternatively or in addition, the blow tube is fully inflated after bonding both wall areas. Thus, the full inflation advantageously occurs during or after ejecting the first or second mold slider.

The method according to the present invention and its advantageous further refinements establish, when molding the parison in the blow tube, a welding of wall areas of the blow tube is affected in the interior of the respective mold cavity and, for this reason, in the interior or intermediate area of the produced hollow body. The mold sliders according to the present invention may be installed from one or two sides of the respective blow mold or respective blow tube. According to the present invention, interior ribs or stiffeners may be produced at the same time when a closed, exterior surface is formed. For this purpose, a particular dimensional matching of the produced component is not required. Furthermore, the stiffener is produced with the same material as the surface of the component, so that recycling the material is particularly easy.

In the following, an exemplary embodiment of the achievement according to the present invention is illustrated in greater detail on the basis of the appended schematic drawings.

### BRIEF DESCRIPTION OF THE DRAWINGS

FIG. 1 shows a cross-section of the device according to the present invention in a first step of a method according to the present invention.

FIG. 2 shows the cross-section according to FIG. 1 in a second step of the method according to the present invention.

FIG. 3 shows the cross-section according to FIG. 1 in a third step of the method according to the present invention.

FIG. 4 shows the cross-section according to FIG. 1 in a fourth step of the method according to the present invention.

### DETAILED DESCRIPTION

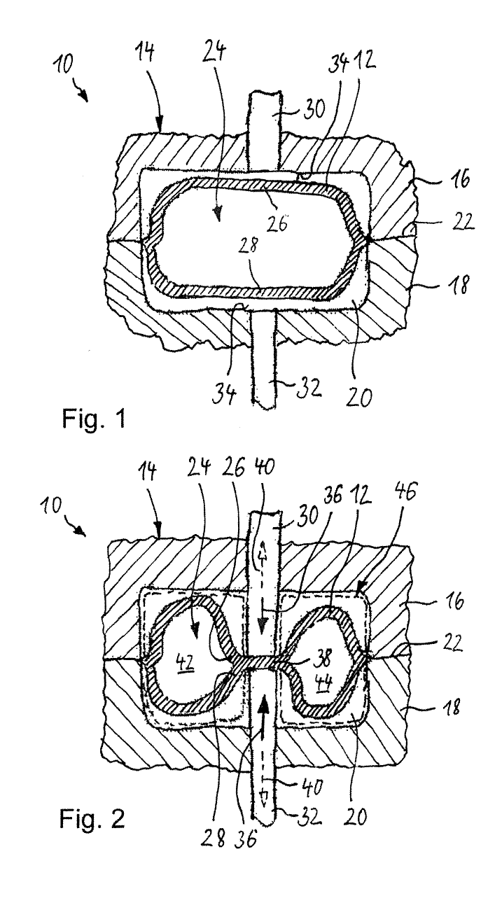

FIGS. 1 through 4 show a device 10 for blow-molding a blow tube 12 made of thermoplastic plastic. Device 10 includes a blow mold 14, which is formed by a first blow-mold half 16 and a second blow-mold half 18. Two blow-mold halves 16 and 18 close around a mold cavity 20, and they adjoin at a mold separation plane 22 at the edge of mold cavity 20.

In a first method step according to FIG. 1, blow tube 12 is brought into mold cavity 20 as a hot and, for this reason, flexible parison. The parison, by closing two blow-mold halves 16 and 18 into a closed blow mold 12, is, if applicable, clamped and, for this reason, positioned at mold separation plane 22.

Blow tube 12 has inside of blow mold 14 a first wall area 26 and a second wall area 28, which are situated opposite each other at two blow-mold halves 16 and 18. Behind these two wall areas 26 or 28, a first mold slider 30 or a second mold slider 32 are respectively located on the outer side of mold cavity 20 in blow mold 14. Mold sliders 30 or 32 may be moved into and out of mold cavity 20.

During the insertion of blow tube 12 into mold cavity 20, as shown in FIG. 1, form sliders 30 or 32 are situated in blow mold 14 and, in this instance, respectively form with this blow mold 14 at the boundary of mold cavity 20 a smooth surface 34. In this method step, the interior shape of mold cavity 20 having smooth surfaces 34 thus corresponds with the interior shape of a conventional or an ordinary mold cavity for inserting a blow tube.

As shown in FIG. 2, only after pre-inflating blow tube 12, two mold sliders 30 and 32 are moved, according to an arrow 36, opposite each other into mold cavity 20. By moving or injecting two mold sliders 30 and 32, wall areas 26 and 28 situated in front of mold sliders 30 and 32 are molded into mold cavity 20.

The travel path of two mold sliders 30 and 32 is chosen as far or long in such a manner that two wall areas 26 and 28 in the interior of the mold cavity come into contact with each other and in this contact area bond to an adhesion 38. Adhesion 38 of two wall areas 26 and 28 results, in particular, because the material of blow tube 12 is, at this stage of the method, still heated and, for this reason, thermoplastically meallable and adhesive.

After adhesion 38 has formed, two mold sliders 30 and 32 subsequently are again fully moved out of mold cavity 20. In this manner, tube interior 24 is divided into a first [part] 42 and a second part 44, and a smooth surface 34 immediately forms again at the boundary of mold cavity 20.

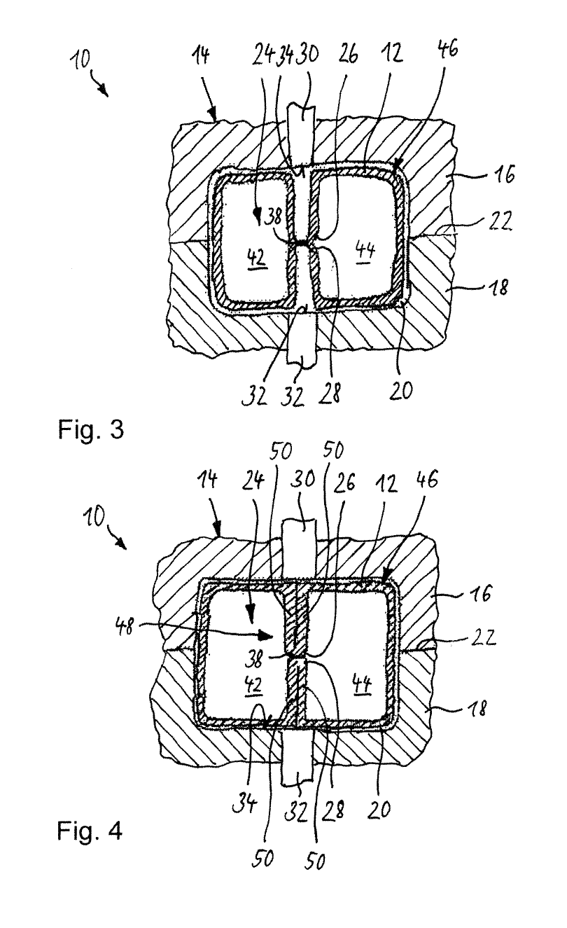

As shown in FIG. 2 and then also in FIG. 3, these two parts 42 and 44 of tube interior 24 are subsequently inflated to a finished form 46 of blow tube 12 by a blowing device not individually shown. For this purpose, the material of blow tube 12 is forced from the inside to the outside against the interior walls of two blow-mold halves 16 and 18. As then shown in FIG. 4, in this finished form 46, the material of blow tube 12 thus fully abuts against the interior side at smooth surface 34 even in front of both retracted mold sliders 30 and 32.

At the same time, at the inside of blow tube 12, finished form 46 forms a rib 48, which core is formed by adhesion 38. From adhesion 38, a total of four rib side walls 50 stick outwards, from which, on the basis of the high pressure when fully inflating blow tube 12, the blowing device presses respectively two rib side walls 50 directly against each other. These two rib side walls 50 thus form a rib in itself, which material also bonds together. The material is cooled by fully inflating and abutting the material of blow tube 12 against the interior side of blow mold 14. This results in the material to harden and a finished form is created, which has interior rib 48 but, at the same time, is completely smooth on the outside, as in the case of a conventional blow mold.

In conclusion, it shall be noted that all features recited in the application material and, in particular, in the dependent claims, despite the formally carried-out reference back to one or a plurality of specific claims, are also to be independently claimed, individually or in an arbitrary number of combinations.

### LIST OF REFERENCE CHARACTERS

10 Device for blow-molding
12 Blow tube
14 Blow mold
16 First blow-mold half
18 Second blow-mold half
20 Mold cavity
22 Mold separation plane
24 Tube interior
26 First wall area
28 Second wall area
30 First mold slider
32 Second mold slider
34 Smooth surface
36 Arrow: in-moving a mold slider
38 Adhesion
40 Arrow: out-moving a mold slider
42 First part of the tube interior
44 Second part of the tube interior
46 Finished form of blow tube
48 Rib
50 Ribbed side wall

What is claimed is:

1. A device (10) for blow-molding a blow tube (12) comprising a blow mold, into which mold cavity (20) the blow tube (12) has to be at least partially received, and comprising a mold slider (30, 32) injectable into the mold cavity (20), in which the mold slider (30, 32) has to move a first wall area (26) of the blow tube (12) into the mold cavity (20) up to a second wall area (28) opposite of the blow tube (12) in such a manner that an adhesion (38) of both wall areas results.

2. The device of claim 1, in which the form slider (30, 32) after the adhesion (38) of the first and second wall areas (26, 28) has to again be fully moved out of the mold cavity (20).

3. The device of claim 1, further comprising a second mold slider (32), by which the second wall area (28) of the blow tube (12) is moved into the mold cavity (20).

4. The device of claim 1, further comprising a blowing device, by which the blow tube (12) before the adhesion (38) of the first and second wall areas (26, 28) is partially inflatable.

5. The device of claim 1, further comprising a blowing device, by which the blow tube (12) after the adhesion (38) of the first and second wall areas (26, 28) is fully inflatable.

6. A method for blow molding a blow tube (12) comprising the following steps:
inserting a blow tube (12) into a mold cavity (20) of a blow mold (14);
injecting a mold slider (30, 32) into the mold cavity (20) and in-moving a wall area (26, 28) of the blow tube (12) into the mold cavity (20) until an adhesion (38) of the wall area (26) with an opposite wall area (28) of the blow tube (12) occurs.

7. The method of claim 6, further comprising fully ejecting the mold slider (30, 32) after the adhesion (38) of the two wall areas (26, 28) from the mold cavity (20).

8. The method of claim 6, further comprising injecting a second mold slider (32) into the mold cavity (20) and moving the opposite wall area (28) of the blow tube (12) into the mold cavity up to adhesion (38) of the two wall areas (26, 28).

9. The method of claim 6, further comprising partially inflating the blow tube (12) before the adhesion (38) of the two wall areas (26, 28).

10. The method of claim 6, further comprising fully inflating the blow tube (12) after the adhesion (38) of the two wall areas (26, 28).
